(19) United States
(12) Patent Application Publication
(10) Pub. No.: US 2013/0084516 A1
(43) Pub. Date: Apr. 4, 2013

(54) Poly(Methyl Methacrylate) Additive to Polyelectrolyte Membrane

(71) Applicants: Michael R. Schoeneweiss, West Henrietta, NY (US); Timothy J. Fuller, Pittsford, NY (US); Lijun Zou, Rochester, NY (US)

(72) Inventors: Michael R. Schoeneweiss, West Henrietta, NY (US); Timothy J. Fuller, Pittsford, NY (US); Lijun Zou, Rochester, NY (US)

(73) Assignee: GM GLOBAL TECHNOLOGY OPERATIONS LLC, Detroit, MI (US)

(21) Appl. No.: 13/249,681

(22) Filed: Sep. 30, 2011

(51) Int. Cl. H01M 8/10; H01M 2/18; H01M 2/16

(52) U.S. Cl. 429/494; 429/492; 429/493

(57) ABSTRACT

An ion-conducting membrane for fuel cells includes an ion-conducting polymer having protogenic groups and poly(methyl methacrylate). Characteristically, the ion-conducting layer is planar having a thickness from 1 microns to 200 microns. A membrane electrode assembly includes the ion-conducting membrane interposed between a cathode layer and an anode layer.

### TECHNICAL FIELD

The field to which the disclosure generally relates is to polymer electrolytes and to fuel cells.

### BACKGROUND

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”) to provide ion transport between the anode and cathode while also serving as an electrical insulator.

In proton exchange membrane type fuel cells, hydrogen is supplied to the anode as fuel, and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel to disperse over the surface of the membrane facing the fuel supply electrode. Each electrode has finely divided catalyst particles (for example, platinum particles), supported on carbon particles, to promote oxidation of hydrogen at the anode, and reduction of oxygen at the cathode. Protons flow from the anode through the ion-conductive polymer membrane to the cathode where they combine with oxygen to form water which is discharged from the cell. Typically, the ion-conductive polymer membrane includes a perfluorosulfonic acid (PFSA) ionomer.

The MEA is sandwiched between a pair of porous gas diffusion layers (“GDL”), which in turn are sandwiched between a pair of electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cells in stacks in order to provide high levels of electrical power.

Polymer electrolytes play an important part in determining the efficiency of PEM fuel cells. To achieve optimal performance, the polymer electrolyte must maintain a high ionic conductivity and mechanical stability at both high and low relative humidity. The polymer electrolyte also needs to have excellent chemical stability for long product life and robustness. Although the polymeric membranes being used for fuel cells work reasonably well, chemical degradation remains a problem.

Accordingly, there is a need for improved ion-conducting polymer compositions and membranes formed therefrom.

### SUMMARY OF THE INVENTION

The present invention solves one or more problems of the prior art by providing in at least one embodiment an ion-conducting polymeric membrane for fuel cells. The ion-conducting polymer having protogenic groups and poly(methyl methacrylate).

In another embodiment, a membrane electrode assembly for a fuel cell incorporating the ion-conducting membrane set forth above is provided. The membrane electrode assembly includes an anode layer, a cathode layer, and an ion-conducting membrane positioned between the anode layer and the cathode layer. The ion-conducting membrane comprises an ion-conducting polymer having protogenic groups and poly(methyl methacrylate). Advantageously, the polymethyl methacrylate may be added to the ion-conducting polymer without significant loss of fuel cell performance and with a concurrent increase in chemical durability.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 provides a schematic illustration of a fuel cell incorporating the polymers of an embodiment of the present invention.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” “block”, “random,” “segmented block,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

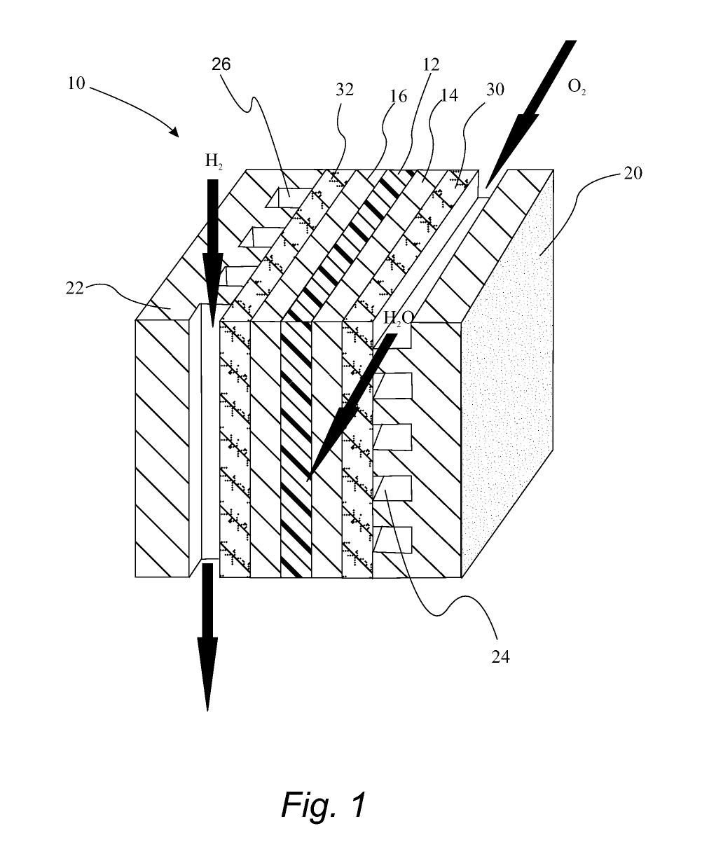

With reference to FIG. 1, a fuel cell that incorporates a polymer electrolyte including polymers from the invention is provided. PEM fuel cell 10 includes polymeric ion-conductive membrane 12 disposed between cathode catalyst layer 14 and anode catalyst layer 16. Polymeric ion-conductive membrane 12 includes one or more of the polymers set forth below. Fuel cell 10 also includes conductive plates 20, 22, gas channels 24 and 26, and gas diffusion layers 30 and 32.

In an embodiment, the ion-conducting membrane is incorporated into the fuel cell of FIG. 1 comprising an ion-conducting polymer having protogenic groups and poly(methyl methacrylate). Characteristically, the ion-conducting layer is planar and has a thickness from 1 microns to 200 microns. In a variation, the protogenic groups comprise a component selected from the group consisting of —SO₂X, —PO₃H₂, —COX, and combinations thereof and X is —OH, a halogen, or an ester.

In a variation of the ion-conducting membrane, the poly(methyl methacrylate) is present in an amount less than about 30 weight percent of the total weight of the ion-conducting membrane. In a refinement, the poly(methyl methacrylate) is present in an amount from about 0.5 to about 30 weight percent of the total weight of the ion-conducting membrane. In another refinement, the poly(methyl methacrylate) is present in an amount from about 1 to about 20 weight percent of the total weight of the ion-conducting membrane. In another refinement, the poly(methyl methacrylate) is present in an amount from about 10 to about 20 weight percent of the total weight of the ion-conducting membrane.

In a variation of the ion-conducting membrane, the ion-conducting polymer having protogenic groups comprises a component selected from the group consisting of perfluorosulfonic acid polymer, hydrocarbon based ionomer, sulfonated polyether ether ketone polymer, perfluorocyclobutane polymers, and combinations thereof.

In a refinement, the ion-conducting polymer comprises a copolymer containing a polymerization unit based on a perfluorovinyl compound represented by:

CF₂═CF—(OCF₂CFX¹)ₘ—Oᵣ—(CF₂)_{q}—SO₃H

where m represents an integer from 0 to 3, q represents an integer from 1 to 12, r represents 0 or 1, and X¹ represents a fluorine atom or a trifluoromethyl group and a polymerization unit based on tetrafluoroethylene.

In another refinement, the ion-conducting polymers having protogenic groups include ion-conducting polymers having cyclobutyl moieties as disclosed in U.S. Pat. Pub. No. 2007/0099054, U.S. patent application Ser. Nos. 12/197,530 filed Aug. 25, 2008; 12/197,537 filed Aug. 25, 2008; 12/197,545 filed Aug. 25, 2008; and 12/197,704 filed Aug. 25, 2008; the entire disclosures of which are hereby incorporated by reference. In a variation, the cyclobutyl-containing polymers have a polymer segment comprising polymer segment 1:

E₀—P₁—Q₁—P₂ 1

wherein:
Eₒ is a moiety having a protogenic group such as —SO₂X, —PO₃H₂, —COX, and the like;
P₁, P₂ are each independently absent, —O—, —S—, —SO—, —CO—, —SO₂—, —NH—, NR₂—, or —R₃—,
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, perfluoroalkyl ether, alkylether, or C₁₋₂₅ arylene;
X is an —OH, a halogen, an ester, or

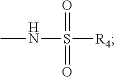

R₄ is trifluoromethyl, C₁₋₂₅ alkyl, C₁₋₂₅ perfluoroalkylene, C₁₋₂₅ aryl, or E₁ (see below); and
Q₁ is a fluorinated cyclobutyl moiety. In a refinement, polymer segment 1 is repeated 1 to 10,000 times.

In variation of the present invention, the cyclobutyl-containing polymers comprise polymer segments 2 and 3:

[E₁(Z₁)_{d}]—P₁—Q₁—P₂ 2

E₂—P₃—Q₂—P₄ 3

wherein:
Z₁ is a protogenic group such as —SO₂X, —PO₃H₂, —COX, and the like;
E₁ is an aromatic containing moiety;
E₂ is an unsulfonated aromatic-containing and/or aliphatic-containing moiety;
X is an —OH, a halogen, an ester, or

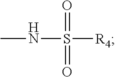

d is the number of Z₁ attached to E₁;
P₁, P₂, P₃, P₄ are each independently absent, —O—, —S—, —SO—, —CO—, —SO₂—, —NH—, NR₂—, or —R₃—;
R₂ is C₁₋₂₅ alkyl, C₁₋₂₅ aryl, or C₁₋₂₅ arylene;
R₃ is C₁₋₂₅ alkylene, C₁₋₂₅ perfluoroalkylene, perfluoroalkyl ether, alkylether, or C₁₋₂₅ arylene;
R₄ is trifluoromethyl, C₁₋₂₅ alkyl, C₁₋₂₅ perfluoroalkylene, C₁₋₂₅ aryl, or another E₁ group; and
Q₁, Q₂ are each independently a fluorinated cyclobutyl moiety. In one refinement, d is equal to the number of aromatic rings in E₁. In another refinement, each aromatic ring in E₁ can have 0, 1, 2, 3, or 4 Z₁ groups.

In another variation of the present embodiment, the cyclobutyl-containing polymers comprise segments 4 and 5:

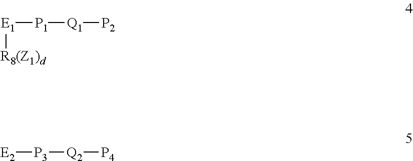

wherein:
Z₁ is a protogenic group such as —SO₂X, —PO₃H₂, —COX, and the like;
E₁, E₂ are each independently an aromatic-containing and/or aliphatic-containing moiety;
X is an —OH, a halogen, an ester, or

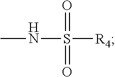

d is the number of Z₁ attached to R₈;
P₁, P₂, P₃, P₄ are each independently absent, —O—, —S—, —SO—, —CO—, —SO₂—, —NH—, NR₂—, or —R₃—;
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, perfluoroalkyl ether, alkylether, or C₁₋₂₅ arylene;
R₄ is trifluoromethyl, C₁₋₂₅ alkyl, C₁₋₂₅ perfluoroalkylene, C₁₋₂₅ aryl, or another E₁ group;
R₈(Z₁)_{d} is a moiety having d number of protogenic groups; and
Q₁, Q₂ are each independently a fluorinated cyclobutyl moiety. In a refinement of this variation, R⁸ is C₁₋₂₅ alkylene, C₁₋₂₅ perfluoroalkylene, perfluoroalkyl ether, alkylether, or C₁₋₂₅ arylene. In one refinement, d is equal to the number of aromatic rings in R₈. In another refinement, each aromatic ring in R₈ can have 0, 1, 2, 3, or 4 Z₁ groups. In still another refinement, d is an integer from 1 to 4 on average;

In another variation, the cyclobutyl-containing polymers comprise segments 6 and 7:

E₁(SO₂X)_{d}—P₁—Q₁—P₂ 6

E₂—P₃—Q₂—P₄ 7

connected by a linking group L₁ to form polymer units 8 and 9:

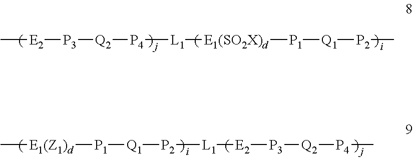

wherein:
Z₁ is a protogenic group such as —SO₂X, —PO₃H₂, —COX, and the like;
E₁ is an aromatic-containing moiety;
E₂ is an unsulfonated aromatic-containing and/or aliphatic-containing moiety;
L₁ is a linking group;
X is an —OH, a halogen, an ester, or

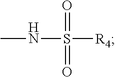

d is a number of Z₁ functional groups attached to E₁;
P₁, P₂, P₃, P₄ are each independently absent, —O—, —S—, —SO—, —SO₂—, —CO—, —NH—, NR₂—, or —R₃—, and
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, or C₁₋₂₅ arylene;
R₄ is trifluoromethyl, C₁₋₂₅ alkyl, C₁₋₂₅ perfluoroalkylene, C₁₋₂₅ aryl, or another E₁ group;
Q₁, Q₂ are each independently a fluorinated cyclobutyl moiety;
i is a number representing the repetition of polymer segment 6 with i typically from 1 to 200; and
j is a number representing the repetition of a polymer segment 7 with j typically being from 1 to 200. In one refinement, d is equal to the number of aromatic rings in E₁. In another refinement, each aromatic ring in E₁ can have 0, 1, 2, 3, or 4 Z₁ groups. In still another refinement, d is an integer from 1 to 4 on average.

In still another variation, the cyclobutyl-containing polymers comprise polymer segments 10 and 11:

E₁(Z₁)_{d}—P₁—Q₁—P₂ 10

E₂(Z₁)_{f}—P₃ 11

wherein:
Z₁ is a protogenic group such as —SO₂X, —PO₃H₂, —COX, and the like;
E₁, E₂ are each independently an aromatic or aliphatic-containing moiety wherein at least one of E₁ and E₂ includes an aromatic substituted with Z₁;
X is an —OH, a halogen, an ester, or

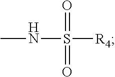

d is the number of Z₁ functional groups attached to E₁;
f is the number of Z₁ functional groups attached to E₂;
P₁, P₂, P₃ are each independently absent, —O—, —S—, —SO—, —SO₂—, —CO—, —NH—, NR₂—, or —R₃—;
R₂ is C₁₋₂₅ alkyl, C₁₋₂₅ aryl, or C₁₋₂₅ arylene;
R₃ is C₁₋₂₅ alkylene, C₁₋₂₅ perfluoroalkylene, perfluoroalkyl ether, alkyl ether, or C₁₋₂₅ arylene;
R₄ is trifluoromethyl, C₁₋₂₅ alkyl, C₁₋₂₅ perfluoroalkylene, C₁₋₂₅ aryl, or another E₁ group; and
Q₁ is a fluorinated cyclobutyl moiety,
with the proviso that when d is greater than zero, f is zero and when f is greater than zero d is zero. In one refinement, d is equal to the number of aromatic rings in E₁. In another refinement, each aromatic ring in E₁ can have 0, 1, 2, 3, or 4 Z₁ groups. In still another refinement, d is an integer from 1 to 4 on average. In one refinement, f is equal to the number of aromatic rings in E₂. In another refinement, each aromatic ring in E₂ can have 0, 1, 2, 3, or 4 Z₁ groups. In still another refinement, f is an integer from 1 to 4 on average.

Examples for Q₁ and Q₂ in the above formulae are:

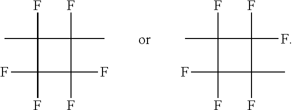

In each of the formulae 2-11, E₁ and E₂ include one or more aromatic rings. For example, E₁ and E₂, include one or more of the following moieties:

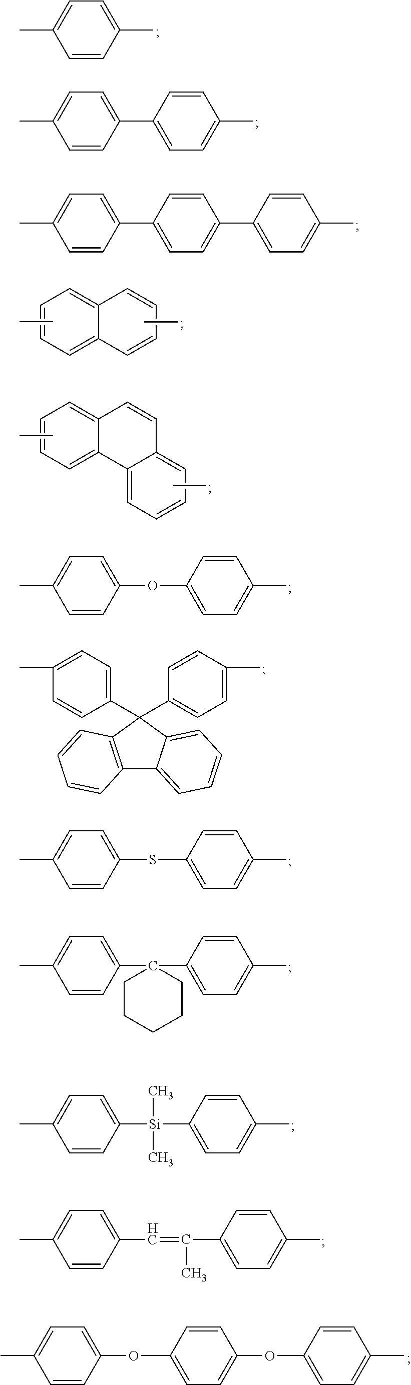

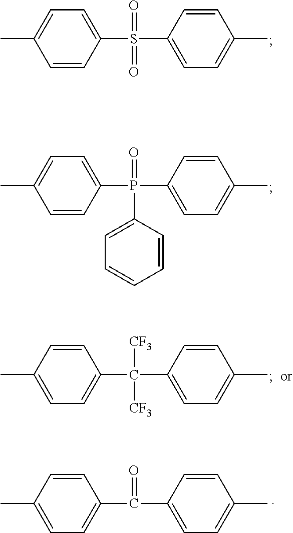

Examples of L₁ include the following linking groups:

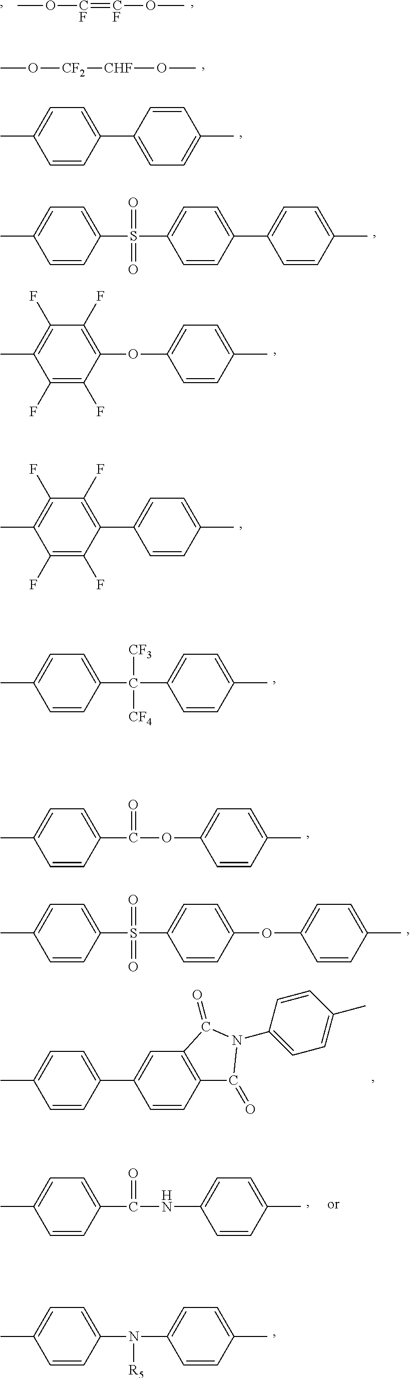

where R₅ is an organic group, such as an alkyl or acyl group.

In yet another variation of the present invention, the ion-conducting membrane also includes a non-ionic polymer such as a fluoro-elastomer. The fluoro-elastomer may be any elastomeric material comprising fluorine atoms. The fluoro-elastomer may comprise a fluoropolymer having a glass transition temperature below about 25° C., or preferably, below 0° C. The fluoro-elastomer may exhibit an elongation at break in a tensile mode of at least 50% or preferably at least 100% at room temperature. The fluoro-elastomer is generally hydrophobic and substantially free of ionic groups. The fluoro-elastomer polymer chain may have favorable interaction with the hydrophobic domain of the second polymer described above. Such favorable interaction may facilitate formation of a stable, uniform and intimate blend of the two materials. The fluoro-elastomer may be prepared by polymerizing at least one fluoro-monomer such as vinylidene fluoride, tetrafluoroethylene, hexafluoropropylene, vinylfluoride, chlorotrifluoroethylene, perfluoromethylvinyl ether, and trifluoroethylene. Examples of elastomers include poly(vinylidene fluoride), poly(tetrafluoroethylene), poly(hexafluoropropylene), poly(vinylfluoride), poly(chlorotrifluoroethylene), poly(perfluoromethylvinyl ether), poly(trifluoroethylene), and combinations thereof. The fluoro-elastomer may also be prepared by copolymerizing at least one fluoro-monomer and at least one non-fluoro-monomer such as ethylene, propylene, methyl methacrylate, ethyl acrylate, styrene, vinylchloride and the like. The fluoro-elastomer may be prepared by free radical polymerization or anionic polymerization in bulk, emulsion, suspension and solution. Examples of copolymeric fluoro-elastomers include poly(tetrafluoroethlyene-co-ethylene), poly(vinylidene fluoride-co-hexafluoropropylene), poly(tetrafluoroethylene-co-propylene), terpolymer of vinylidene fluoride, hexafluoropropylene and tetrafluoroethylene, and terpolymer of ethylene, tetrafluoroethylene and perfluoromethylvinylether. Some of the fluoro-elastomers are commercially available from Arkema under trade name Kynar Flex™. and Solvay Solexis™. under the trade name Technoflon™, from 3M under the trade name Dyneon™, and from DuPont under the trade name Viton™. For example, Kynar Flex™ 2751 is a copolymer of vinylidene fluoride and hexafluoropropylene with a melting temperature between about 130° C. and 140° C. The glass transition temperature of Kynar Flex™ 2751 is about −40 to −44° C. The fluoro-elastomer may further comprise a curing agent to allow crosslinking reaction after being blended with the second polymer. In a refinement, the fluoro-elastomer is present in an amount from about in an amount from about 0.1 to about 40 weight percent of the ion-conducting membrane. In another refinement, the fluoro-elastomer is present in an amount from about 10 weight percent to about 30 weight percent of the total weight of the ion-conducting membrane.

The following examples illustrate the various embodiments of the present invention. Those skilled in the art will recognize many variations that are within the spirit of the present invention and scope of the claims.

### Comparative Example 1

### PFCB Ionomer Control Membrane

The perfluorocyclobutane ionomer (1 gram, TCT 840B, Tetramer Technologies, Pendleton, S.C.) with the approximate structure shown below is dissolved in N,N-dimethylacetamide (9 grams) and is coated onto window-pane glass with a 6-mil gap Bird Applicator (Paul N. Gardner Co., Pompano Beach, Fla.) and an Erichsen coater. The wet coating is dried at 80° C. and optionally annealed at 140° C. for 4 hours. The resultant film is floated off the glass with water and then is air-dried.

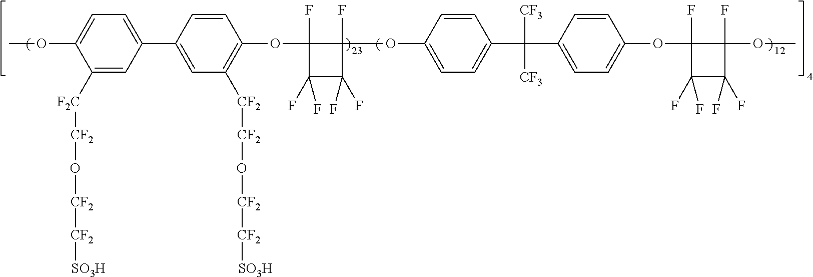

A fuel cell is assembled with a 53 cm² active area cathode consisting of 0.4 mg/cm² Pt on carbon catalyst (Tanaka) applied to a graphitized carbon gas diffusion layer (Mitsubishi Rayon Corp.) having a Teflon-carbon black microporous layer. The 14-micrometer thick membrane prepared as described above with a 10 cm by 10 cm dimension is assembled as a loose-lay sandwich between the cathode and an anode with 0.05 mg/cm² Pt on graphitized carbon gas diffusion layer using counter-flow serpentine graphite flow fields and United Technologies hardware. The fuel cell is operated at 150 kPa (gauge), 2/1.8 stoic (H₂/air), 62° C. dew point, at 55, 85 and 150% relative humidity outlet gas streams. At 1.5 A/cm², the voltages measured for this membrane at 55, 85, and 150% are 0.458, 0.604, and 0.583 volts, respectively. These results are summarized in Table 1. This membrane survives 345-450 hours of cycling in small-scale durability testing with successively repeated polarization curves (at 85%, 110%, 150%, 75%, and 85% relative humidity gas outlet streams) without subgskets which acerbates chemical failure. Nafion DE2020 ionomer (E. I. DuPont de Nemours) fails similarly after 100 hours. Failures occur at the edge of the catalyst where membrane and gases interact and highly destructive free radicals are generated in these regions.

### Example 1

### PFCB Ionomer with 10% Poly(Methyl Methacrylate)

The perfluorocyclobutane ionomer (1 gram, TCT 840B, Tetramer Technologies, Pendleton, S.C.), and poly(methyl methacrylate) (0.111 gram added as 1.111 grams of a 10 wt. % solids solution in N,N-dimethylacetamide) is dissolved in N,N-dimethylacetamide (7.89 grams) and the mixture is coated onto window-pane glass with a 6-mil gap Bird Applicator (Paul N. Gardner Co., Pompano Beach, Fla.) and an Erichsen coater. The wet coating is dried at 80° C. and optionally annealed at 140° C. for 4 hours. The resultant film is floated off the glass with water and then is air-dried. The fuel cell is made and tested as described in Comparative Example 1. At 1.5 A/cm², the voltages measured for this membrane at 55, 85, and 150% are 0.450, 0.610, and 0.625 volts, respectively. These results are summarized in Table 1. The performance of a TCT 840B membrane with 10 wt. % PMMA (Example 1) compares favorably to that without PMMA (Comparative Example 1). The membrane lasted more than 700 hours in the accelerated durability test described in Comparative Example 1. Nafion DE2020 ionomer (E. I. DuPont de Nemours) with 0.02 mole % of Ce³⁺ as Ce₂(CO₃)₃ per SO₃H group fails after 700 hours in this test.

### Example 2

### PFCB Ionomer with 20% Poly(Methyl Methacrylate)

The perfluorocyclobutane ionomer (1 gram, TCT 840B, Tetramer Technologies, Pendleton, S.C.), and poly(methyl methacrylate) (0.250 gram added as 2.50 grams of a 10 wt. % solids solution in N,N-dimethylacetamide) is dissolved in N,N-dimethylacetamide (9.00 grams) and the mixture is coated onto window-pane glass with a 6-mil gap Bird Applicator (Paul N. Gardner Co., Pompano Beach, Fla.) and an Erichsen coater. The wet coating is dried at 80° C. and optionally annealed at 140° C. for 4 hours. The resultant film is floated off the glass with water and then is air-dried. The fuel cell is made and tested as described in Comparative Example 1. The voltages measured for this membrane are 0.471 volt at 55% relative humidity (1.2 A/cm²), 0.593 volt at 85% relative humidity (1.5 A/cm²), and 0.613 volt at 150% relative humidity (1.5 A/cm²). These results are summarized in Table 1. This membrane did not deliver more than 0.2 volt at 1.5 A/cm² and 55% relative humidity, and so its dry performance was lower than that of a similar membrane with 10% PMMA (Example 1).

### Example 3

### PFCB Ionomer with 10% Poly(Methyl Methacrylate) and 20% Kynar Flex 2751

The perfluorocyclobutane ionomer (1 gram, TCT 840B, Tetramer Technologies, Pendleton, S.C.), poly(methyl methacrylate) (0.1429 gram added as 1.429 grams of a 10 wt. % solids solution in N,N-dimethylacetamide), and Kynar Flex 2751 (0.2857 gram added as 1.905 grams of a 15 wt. % solids solution in N,N-dimethylacetamide) is dissolved in N,N-dimethylacetamide (9.87 grams) and the mixture is coated onto window-pane glass with a 6-mil gap Bird Applicator (Paul N. Gardner Co., Pompano Beach, Fla.) and an Erichsen coater. The wet coating is dried at 80° C. and optionally annealed at 140° C. for 4 hours. The resultant film is floated off the glass with water and then is air-dried. The fuel cell is made and tested as described in Comparative Example 1. At 1.5 A/cm², the voltages measured for this membrane at 55, 85, and 150% are 0.388, 0.601, and 0.616 volts, respectively. These results are summarized in Table 1. The performance of the membrane of Example 3 was better than that of Example 2. Moreover, the durability of this membrane was greater than 700 hours under conditions described in Comparative Example 1. The terpolymer blend appeared to be compatible in that clear transparent coatings were obtained.

### Example 4

### PFCB Ionomer with 30% Poly(Methyl Methacrylate)

The perfluorocyclobutane ionomer (1 gram, TCT 840B, Tetramer Technologies, Pendleton, S.C.), and poly(methyl methacrylate) (0.4286 gram added as 4.286 grams of a 10 wt. % solids solution in N,N-dimethylacetamide) is dissolved in N,N-dimethylacetamide (9.00 grams) and the mixture is coated onto window-pane glass with a 6-mil gap Bird Applicator (Paul N. Gardner Co., Pompano Beach, Fla.) and an Erichsen coater. The wet coating is dried at 80° C. and optionally annealed at 140° C. for 4 hours. The resultant film is floated off the glass with water and then is air-dried. The fuel cell is made and tested as described in Comparative Example 1. The voltages measured for this membrane are 0.500 volt at 55% relative humidity (0.8 A/cm²), 0.549 volt at 85% relative humidity (1.5 A/cm²), and 0.615 volt at 150% relative humidity (1.5 A/cm²). These results are summarized in Table 1. This membrane did not deliver more than 0.2 volt at 1.0 A/cm² and 55% relative humidity, and so its dry performance was much lower than that of a similar membrane made with 20% PMMA (Example 2). Clear transparent coatings of the copolymer blends are observed.

TABLE 1
Composition and Performance of PFCB Membrane (TCT840B)
with Poly(Methyl Methacrylate) (PMMA) Additive

| | Sample | V at | | V at | | V at |
|---|---|---|---|---|---|---|
| | (membrane | 55% | A/ | 85% | A/ | 150% |
| Example | thickness) | R.H. | cm² | R.H. | cm² | R.H. |
| Comparative | TCT 840B (14 μm) | 0.458 | 1.5 | 0.604 | 1.5 | 0.583 |
| Example 1 | | | | | | |
| Example 1 | TCT 840B + 10% | | | | | |
| | PMMA (14 μm) | 0.450 | 1.5 | 0.610 | 1.5 | 0.625 |
| Example 2 | TCT 840B + 20% | 0.471 | 1.2 | 0.593 | 1.5 | 0.613 |
| | PMMA (14 μm) | | | | | |
| Example 3 | TCT 840B + 10% | 0.388 | 1.5 | 0.601 | 1.5 | 0.616 |
| | PMMA + 20% | | | | | |
| | Kynar Flex | | | | | |
| | 2751 (14 μm) | | | | | |
| Example 4 | TCT 840B + 30% | 0.500 | 0.8 | 0.549 | 1.5 | 0.615 |
| | PMMA (14 μm) | | | | | |

### Example 5

### Nafion 1000 with 10% Poly(Methyl Methacrylate)

Nafion DE2020 ionomer (1 gram, DuPont de Nemours) in N,N-dimethylacetamide, and poly(methyl methacrylate) (0.111 gram added as 1.111 grams of a 10 wt. % solids solution in N,N-dimethylacetamide) is dissolved in N,N-dimethylacetamide (9.00 grams), and the mixture is coated onto window-pane glass with a 6-mil gap Bird Applicator (Paul N. Gardner Co., Pompano Beach, Fla.) and an Erichsen coater. The wet coating is dried at 80° C. and then annealed at 140° C. for 16 hours. The resultant 12-μm film is floated off the glass with water and then is air-dried. The fuel cell is made and tested as described in Comparative Example 1. At 1.5 A/cm², the voltages measured for this membrane at 55, 85, and 150% are 0.0.521, 0.581, and 0.601 volts, respectively. The durability of this membrane was greater than 700 hours under conditions described in Comparative Example 1. Clear transparent coatings of the copolymer blends are observed.

Kynar Flex and poly(methyl methacrylate) form compatible blends. Moreover, PFCB ionomers and PFSA ionomers form compatible blends with both Kynar Flex and poly(methyl methacrylate). Ternary blends are formed from mixtures of PFCB or PFSA ionomers, poly(methyl methacrylate) and Kynar Flex. Moreover, PFCB and PFSA ionomers are compatible. It is possible that PFCB and PFSA ionomers are compatible with poly(methylmethacrylate) and Kynar Flex as well. Moreover, poly(methyl methacrylate has the added advantage of being a (sacrificial) mitigant towards chemical degradation by radicals formed during fuel cell operation.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A membrane electrode assembly for a fuel cell, the membrane electrode assembly comprising:
an anode layer;
a cathode layer;
an ion-conducting membrane positioned between the anode layer and the cathode layer, the ion-conducting membrane comprising:
an ion-conducting polymer having protogenic groups; and
poly(methyl methacrylate).

2. The membrane electrode assembly of claim 1 wherein the protogenic groups comprise a component selected from the group consisting of —SO₂X, —PO₃H₂, —COX, and combinations thereof and X is —OH, a halogen, or an ester.

3. The membrane electrode assembly of claim 1 wherein the poly(methyl methacrylate) is present in an amount less than about 30 weight percent of the total weight of the ion-conducting membrane.

4. The membrane electrode assembly of claim 1 wherein the poly(methyl methacrylate) is present in an amount from about 1 to about 20 weight percent of the total weight of the ion-conducting membrane.

5. The membrane electrode assembly of claim 1 wherein the ion-conducting polymer having protogenic groups comprises a component selected from the group consisting of perfluorosulfonic acid polymer, hydrocarbon based ionomer, sulfonated polyether ether ketone polymer, sulfonated perfluorocyclobutane polymers, and combinations thereof.

6. The membrane electrode assembly of claim 1 wherein the ion-conducting polymer comprises a copolymer containing a polymerization unit based on a perfluorovinyl compound represented by:
CF₂═CF—(OCF₂CFX¹)ₘ—Oᵣ—(CF₂)_{q}—SO₃H
where m represents an integer from 0 to 3, q represents an integer from 1 to 12, r represents 0 or 1, and X¹ represents a fluorine atom or a trifluoromethyl group and a polymerization unit based on tetrafluoroethylene.

7. The membrane electrode assembly of claim 1 wherein the ion-conducting membrane further comprises a fluoro-elastomer.

8. The membrane electrode assembly of claim 7 wherein the fluoro-elastomer comprises a component selected from the group consisting of poly(vinylidene fluoride), poly(tetrafluoroethylene), poly(hexafluoropropylene), poly(vinylfluoride), poly(chlorotrifluoroethylene), poly(perfluoromethylvinyl ether), poly(trifluoroethylene), and combinations thereof.

9. The membrane electrode assembly of claim 7 wherein the fluoro-elastomer is present in an amount from about 1 weight percent to about 40 weight percent of the total weight of the ion-conducting membrane.

10. The membrane electrode assembly of claim 1 wherein the ion-conducting polymer having protogenic groups includes a cyclobutyl-containing polymer have a polymer segment comprising polymer segment 1:
E₀—P₁—Q₁—P₂ 1
wherein:
Eₒ is a moiety having a protogenic group;
P₁, P₂ are each independently absent, —O—, —S—, —SO—, —CO—, —SO₂—, —NH—, NR₂—, or —R₃—,
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, perfluoroalkyl ether, alkylether, or C₁₋₂₅ arylene;
X is an —OH, a halogen, an ester, or 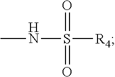
R₄ is trifluoromethyl, C₁₋₂₅ alkyl, C₁₋₂₅ perfluoroalkylene, C₁₋₂₅ aryl, or E₁ (see below); and
Q₁ is a fluorinated cyclobutyl moiety.

11. The membrane electrode assembly of claim 1 wherein the ion-conducting membrane is planar and has a thickness from 1 microns to 200 microns.

12. An ion-conducting membrane comprising:
an ion-conducting polymer having protogenic groups; and
poly(methyl methacrylate)
wherein the ion-conducting layer is planar having a thickness from 1 microns to 200 microns.

13. The ion-conducting membrane of claim 12 wherein the protogenic groups comprise a component selected from the group consisting of —SO₂X, —PO₃H₂, —COX, and combinations thereof and X is —OH, a halogen, or an ester.

14. The ion-conducting membrane of claim 12 wherein the poly(methyl methacrylate) is present in an amount less than about 30 weight percent of the total weight of the ion-conducting membrane.

15. The ion-conducting membrane of claim 12 wherein the poly(methyl methacrylate) is present in an amount from about 1 to about 20 weight percent of the total weight of the ion-conducting membrane.

16. The ion-conducting membrane of claim 12 wherein the ion-conducting polymer having protogenic groups comprises a component selected from the group consisting of perfluorosulfonic acid polymer, hydrocarbon based ionomer, sulfonated polyether ether ketone polymer, sulfonated perfluorocyclobutane polymers, and combinations thereof.

17. The ion-conducting membrane of claim 12 wherein the ion-conducting polymer comprises a copolymer containing a polymerization unit based on a perfluorovinyl compound represented by:
CF₂═CF—(OCF₂CFX¹)ₘ—Oᵣ—(CF₂)_{q}—SO₃H
where m represents an integer from 0 to 3, q represents an integer from 1 to 12, r represents 0 or 1, and X¹ represents a fluorine atom or a trifluoromethyl group and a polymerization unit based on tetrafluoroethylene.

18. The ion-conducting membrane of claim 12 wherein the ion-conducting membrane further comprises a fluoro-elastomer.

19. The ion-conducting membrane of claim 18 wherein the fluoro-elastomer comprises a component selected from the group consisting of poly(vinylidene fluoride), poly(tetrafluoroethylene), poly(hexafluoropropylene), poly(vinylfluoride), poly(chlorotrifluoroethylene), poly(perfluoromethylvinyl ether), poly(trifluoroethylene), and combinations thereof.

20. The ion-conducting membrane of claim 12 wherein the ion-conducting polymer having protogenic groups includes a cyclobutyl-containing polymer having a polymer segment comprising polymer segment 1:
E₀—P₁—Q₁—P₂ 1
wherein:
Eₒ is a moiety having a protogenic group;
P₁, P₂ are each independently absent, —O—, —S—, —SO—, —CO—, —SO₂—, —NH—, NR₂—, or —R₃—,
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, perfluoroalkyl ether, alkylether, or C₁₋₂₅ arylene;
X is an —OH, a halogen, an ester, or 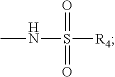
R₄ is trifluoromethyl, C₁₋₂₅ alkyl, C₁₋₂₅ perfluoroalkylene, C₁₋₂₅ aryl, or E₁ (see below); and
Q₁ is a fluorinated cyclobutyl moiety.
